(19) United States
(12) Patent Application Publication
(10) Pub. No.: US 2012/0259544 A1
(43) Pub. Date: Oct. 11, 2012

(54) Feature Location and Resource Management System and Method

(76) Inventors: Christopher Evan Watson, Monroeville, PA (US); John H. Reno, II, Valencia, PA (US); Chadd M. Cron, Gibsonia, PA (US); Scott R. Pavetti, Springdale, PA (US); Christopher S. Detka, Pittsburgh, PA (US); Paul A. Miller, Harmony, PA (US)

(21) Appl. No.: 13/325,491

(22) Filed: Dec. 14, 2011

Related U.S. Application Data
(60) Provisional application No. 61/471,851, filed on Apr. 5, 2011.

(51) Int. Cl. G01C 21/16; G06T 15/00

(52) U.S. Cl. 701/500; 345/419; 704/270; 340/8.1

(57) ABSTRACT

A feature location and management system having: a user-associated marker unit, including: a controller to generate feature data associated with at least one feature located at a site; an activation device to activate the controller to generate the feature data; and a communication device to transmit at least a portion of the feature data. A central control device directly or indirectly receives at least a portion of the feature data transmitted by the marker unit; and generates display data based at least partially on the received feature data.

### CROSS REFERENCE TO RELATED APPLICATIONS

This application claims benefit of priority from U.S. Provisional Patent Application No. 61/471,851, filed Apr. 5, 2011, which is incorporated herein by reference in its entirety.

### BACKGROUND OF THE INVENTION

1. Field of the Invention

The present invention relates generally to navigation, location tracking, and resource management systems and associated methods, and in particular to feature location and resource management systems and methods for use in identifying, tracking, and managing multiple features at a specified site.

2. Description of the Related Art

Emergency responder and other personnel are deployed in a variety of environments and situations where initial knowledge of the site (or structures thereon) is unknown or minimal. Therefore, these personnel are at risk, since they are navigating an unknown or unfamiliar environment. As is known, and in order to effectively navigate inside a structure, a personal inertial navigation unit may be attached to or associated with a user. After initialization, the position (or location) of the user within the environment is inferred from the information and data measured and determined by the individual personal inertial navigation units. Similarly, in such environments, it is common to position vehicles, portable units, or other equipment at the site. The location of these vehicles, portable units, and other equipment is often determined based upon location determination systems, e.g., Global Positioning Systems (GPS), Geographic Information Systems (GIS), and the like.

During a navigation event at the site, all of this information and data is collected (normally through wireless transmission) and used to generate a map or model of the site, including the structures and surrounding areas. This map or model is normally in three dimensions, and used to manage the navigation event and resources involved in the event. For example, when used in the context of a fire event, such a system is used to track both the firefighters (and other personnel) navigating the site and structures, as well as the firefighting vehicles and other equipment deployed at the scene. Accuracy is of the utmost importance, especially for tracking and effectively communicating with the firefighters, both inside the structure and located in the surrounding environment.

While use of this dynamically-generated information and data is crucial to tracking and managing the deployed users and other resources at the site, any additional initial information about the site or structure will lead to increased accuracy, and therefore, user safety. Accordingly, and as is known, certain documents can be provided to the commander or central control personnel before or during the event. For example, site maps, structural maps, site models, diagrams, and other documents can be provided for review—often during the deployment process. However, in such cases, these documents are reviewed by a person or team very quickly due to time pressure, which may lead to error or accidental misinterpretation issues. Furthermore, in many instances, such sufficiently-detailed documentation regarding the specific site or structure is outdated, unavailable, or does not exist.

Therefore, there is a need in the art for improved systems, methods, and techniques that provide or generate accurate and detailed information and data about the site or structures thereon. Further, there is a need in the art for improved systems, methods, and techniques that use existing equipment or devices to generate such information and data for use in creating an accurate map or model of the site. There is also a need for improved navigation, location tracking, and resource management systems and associated methods that lead to enhanced user safety and scene management.

### SUMMARY OF THE INVENTION

Therefore, the present invention generally provides feature location and management systems and methods that address or overcome some or all of the deficiencies of existing navigation, location tracking, and resource management systems, methods, and techniques. Preferably, the present invention provides feature location and management systems and methods that generate improved data and information about a site or structures thereon. Preferably, the present invention provides feature location and management systems and methods that utilize or integrate information generated by existing equipment or devices to create an accurate map or model of the site. Preferably, the present invention provides feature location and management systems and methods that lead to improved scene and resource management.

Accordingly, and in one preferred and non-limiting embodiment, provided is a feature location and management system having at least one user-associated marker unit, including: (a) a controller configured to generate feature data associated with at least one feature located at a site; (b) an activation device in communication with the controller and configured to activate the controller to generate the feature data; and (c) a communication device in communication with the controller and configured to transmit at least a portion of the feature data. A central controller is provided and configured to: (a) directly or indirectly receive at least a portion of the feature data transmitted by the marker unit; and (b) generate display data based at least partially on the received feature data.

In another preferred and non-limiting embodiment, provided is a feature location and management system, including a central controller configured to: (a) directly or indirectly receive feature data associated with at least one feature located at a site; and (b) generate display data based at least partially on the received feature data. The feature data includes at least one of the following: location data, distance data, user data, device data, feature identification data, time data, communication data, motion data, gesture data, description data, resource data, activity data, icon data, navigation data, path data, boundary data, task data, document data, condition data, event data, object data, or any combination thereof.

In a further preferred and non-limiting embodiment, provided is a feature location and management method, including: generating feature data associated with at least one feature located at a site; transmitting at least a portion of the feature data; and directly or indirectly receiving at least a portion of the feature data at a remote location; and generating display data based at least partially on the received feature data.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a feature location and resource management system and method according to the principles of the present invention;

FIG. 2 is a schematic view of another embodiment of a feature location and resource management system and method according to the principles of the present invention;

FIG. 3 is a schematic view of a further embodiment of a feature location and resource management system and method according to the principles of the present invention; and

FIG. 4 is a plan view of one embodiment of a marker unit for use in connection with a feature location and resource management system and method according to the principles of the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention relates to a feature location and management system 10 and associated methods, with particular use in the fields of navigation, location tracking, and resource management. Specifically, the system 10 and method of the present invention facilitates the accurate identification, tracking, and management of multiple features and/or resources at a specified site. Still further, the presently-invented system 10 and method can be used in connection with a variety of applications and environments, including, but not limited to, outdoor navigation, indoor navigation, tracking systems, resource management systems, emergency environments, fire fighting events, emergency response events, warfare, and other areas and applications that are enhanced through effective feature tracking and mapping/modeling.

In addition, it is to be understood that the system 10 and associated method can be implemented in a variety of computer-facilitated or computer-enhanced architectures and systems. Accordingly, as used hereinafter, a “controller,” a “central controller,” and the like refer to any appropriate computing device that enables data receipt, processing, and/or transmittal. In addition, it is envisioned that any of the computing devices or controllers discussed hereinafter include the appropriate firmware and/or software to implement the present invention, thus making these devices specially-programmed units and apparatus.

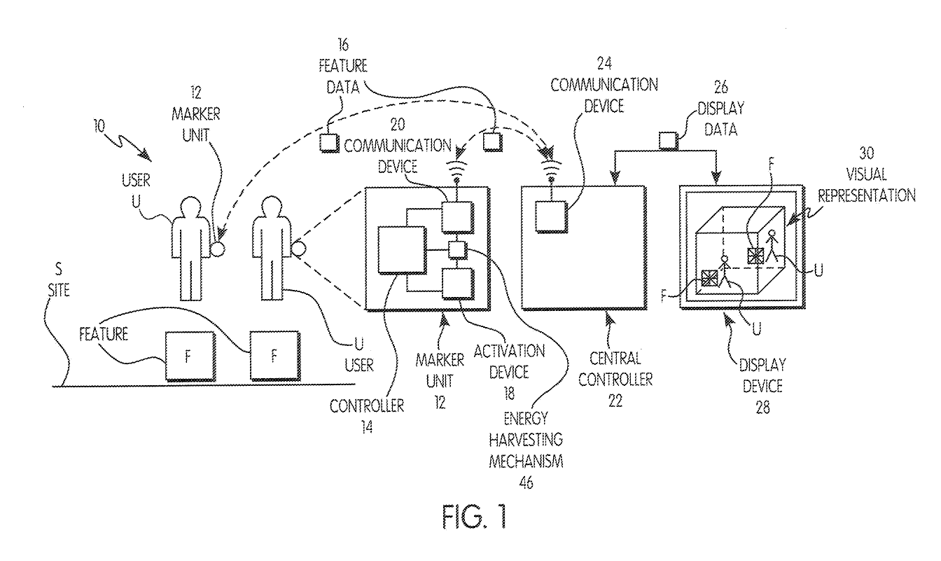

As illustrated in schematic form in FIG. 1, and in one preferred and non-limiting embodiment, the feature location and management system 10 of the present invention includes at least one user-associated marker unit 12. This marker unit 12 includes a controller 14 that is configured or programmed to generate feature data 16, which is associated with at least one feature F located at or on a site S or environment. Further, the marker unit 12 includes an activation device 18 in communication with the controller 14 for activating the controller 14 and causing it to generate the feature data 16. Further, a communication device 20 is included and in communication with the controller 14 for transmitting at least a portion of the feature data 16. Of course, this communication device 20 is also configured or programmed to receive data input.

With specific reference to the communication device 20, this device 20 may be used in connection with a hard-wired or wireless architecture. A wireless system is preferable, thus allowing the appropriate remote broadcast or transmittal of the feature data 16 from the marker unit 12 of each associated user U. If the communication device 20 is a long-range radio device, it includes the capability of wirelessly transmitting the feature data 16 over certain known distances. However, in many particular applications (e.g., the indoor navigation system used by firefighters), a separate communication device can be used in conjunction with a short-range communication device 20 associated with the marker unit 12. Often, in the firefighting application, the user U (or firefighter) wears or uses a long-range radio, which may be programmed or configured to periodically transmit the feature data 16 that is received from the short-range communication of a communication device 20 of the marker unit 12. Of course, as discussed above, any known communication device or architecture can be used to effectively transmit or deliver the feature data 16.

The system 10 of this embodiment further includes at least one central controller 22. This central controller 22 is configured or programmed to directly or indirectly receive at least a portion of the feature data 16 transmitted by the marker unit 12. For example, this central controller 22 may be a remotely-positioned computing device, which also includes a communication device 24. In this embodiment, the communication device 24 is configured or programmed to receive the feature data 16 and further process this data 16 (as discussed hereinafter). Also, this communication device 24 may take a variety of forms and communication functions, as discussed above in connection with communication device 20. In addition, the central controller 22 is configured or programmed to generate display data 26 based at least partially on the received feature data 16. In this manner, the feature F can be identified and/or tracked at or on the site S, or a model thereof.

In another embodiment, the system 10 includes at least one display device 28 configured or programmed to generate a visual representation 30 of at least a portion of the site S based at least partially on the display data 28. This display device 28 may be a computer monitor or other screen that can be used to view visual information. Of course, it is also envisioned that feature data 16 may include aural or tactile data, which may also be processed by the central controller 22 and played through known speaker systems and devices.

In one embodiment, and as illustrated in FIG. 1, the visual representation 30 may be in the form of a three-dimensional visual representation (or model) that is built and represents (or reflects) a physical structure or environment. Accordingly, both the users U and the features F are identified, placed, and tracked within this three-dimensional visual representation 30 of the site S (or structure). Further, it is envisioned that the central controller 22 is configured or programmed to allow for user input for generating a user interface to interact with the visual representation 30 of the site S. This facilitates the effective use of the visual representation 30 (or model) for the marking of various physical locations and landmarks that are mapped in the three-dimensional representation 30, which represents the site S or structure, at the interface.

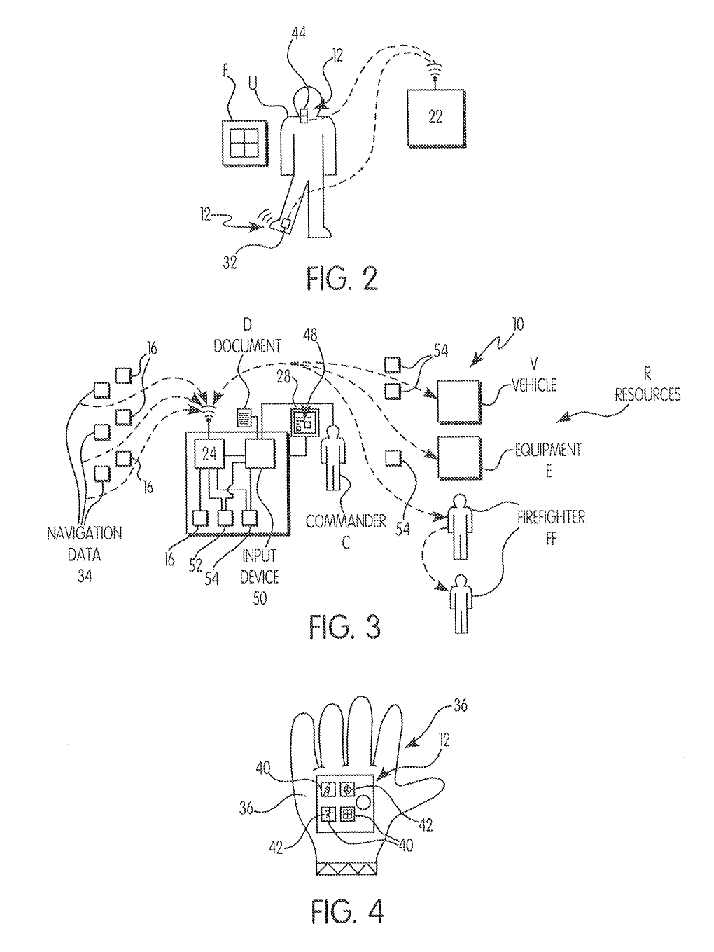

The marker unit 12 may be in a variety of forms and structures. For example, the marker unit 12 may be a physical device that is carried by the user U or integrated into existing or known devices, equipment, or clothing. Accordingly, the marker unit 12 may be in the form of or integrated with the surface of a glove, equipment, an article of clothing, a hat, a boot, and the like. Still further, the marker unit 12 may be in the form of, integrated with, or attached to a personal inertial navigation unit 32 attached to the user U. See FIG. 2. In this embodiment, the personal inertial navigation unit 32 is worn on the boot (or foot area) of the user U. Therefore, the controller 14, activation device 18, and communication device 20 of the marker unit 12 may be added to or integrated with the various components of the personal inertial navigation unit 32. Likewise, the functions performed by the above-discussed controller 14, activation device 18, and communication device 20 may be performed by substantially similar devices or components that are already a part of an existing personal inertial navigation unit 32. Thus, these existing components of the personal inertial navigation unit 32 can be programmed to perform certain additional tasks and data processing activities for effective implementation in the system 10 and method of the present invention.

It is to be understood that a feature F can take a variety of forms and entities. Accordingly, a feature F includes, but is not limited to, a surface, a wall, a ceiling, a floor, a door, a window, a staircase, a ramp, an object, a structure, a user, a vehicle, a point of interest, an entrance, an exit, an elevator, an escalator, a fire point, a structural hazard, a ladder, a drop-off, a condition, an event, and the like. In particular, the user U can use the marker unit 12 to identify any point or feature F in or on the site S (and within or around a structure). For example, the user U can use the system 10 of the present invention to identify viable escape points, certain identifiable waypoints, areas or events of concern, the location of other users and/or equipment, and the like. Further, the feature data 16 may include a variety of information and data points and fields. For example, the feature data 16 includes, but is not limited to, location data, distance data, user data, device data, feature identification data, time data, communication data, motion data, gesture data, description data, resource data, activity data, icon data, navigation data, path data, boundary data, task data, document data, condition data, event data, object data, and the like.

As illustrated in FIG. 2, the activation device 18 can be programmed or configured to activate the controller 14 and cause the feature data 16 to be generated based upon the motion of the user U. For example, the user U may strategically excite the activation device 18 through some movement, such as foot stomping, heel clicking, head movement, hand movement, or other motions or gyrations. In addition, each particular motion may be automatically associated with specified feature F. For example, the number of stomps or clicks may symbolize specific structural attributes or features F, e.g., three heel clicks represents a window.

The above-discussed motion-activation feature may be used within or implemented with the personal inertial navigation unit 32. Accordingly, it is one of the components of the unit 32 (e.g., output from a gyroscope, accelerometer, a magnetometer, etc.) that acts as the activation device 18. Therefore, the navigation routines or software may be additionally programmed or configured to sense such particular excitations and cause the controller 14 to generate and/or transmit the feature data 16.

As discussed, the use of macro movements of the personal inertial navigation unit 32 can be used to facilitate the creation and use of the feature data 16. For example, in one embodiment, the personal inertial navigation unit 32 is worn on the foot or boot of the user U, and the controller 14 is programmed to decode the type of feature F to be placed. This information can be transmitted, along with the navigation data 34 that is already being generated by the unit 32. Accordingly, and as seen in FIG. 3, the central controller 22 receives both the feature data 16 and the navigation data 34 in order to generate the display data 26, which generates or is used to generate the visual representation 30 of the site S and/or structure. Accordingly, the features F will be placed in the model of the site S (or structure), and this model can be used to track both the placement of the features F, as well as the movement of the user U within the structure.

As discussed above, the controller 14 (or associated software used in connection with the controller 14 (or a controller functioning in a similar manner)) can determine or identify a specific gesture, e.g., a foot gesture, and map that to a library of features F, such as hazards. Further, a three-dimensional icon or visual representation can be placed at the location in the model or map by using the navigation data 34 to identify the location of the user U and/or nearby feature F. For example, if the boot-mounted personal inertial navigation unit 32 determines that a quick double tap of the foot parallel to the ground (without the foot's location moving) occurs, it can then determine that this is a “macro” movement (as opposed to a navigational movement) and place the appropriate marker or identify the appropriate feature F. In particular, if the foot or boot was positioned perpendicular to the ground when such a double tap occurs, it may be matched to a different point of interest or feature F. While discussed in connection with the movement of the boot or foot of the user U, any detectable movement event can be used and mapped to a specific feature F or grouping of features F.

In another preferred and non-limiting embodiment, and as illustrated in FIG. 4, the marker unit 12 may be in the form of or integrated with a piece of equipment worn by the user U, such as a glove 36. Further, the activation device 18 is in the form of a surface 38 that is configured or arranged for user contact. While discussed in connection with a glove 36, and as discussed above, the marker unit 12 can be integrated with or associated with any equipment or component worn or associated with the user U. In the example of FIG. 4, the marker unit 12 is integrated with the glove 36 (or glove liner) and uses low-power radio frequency identification tags and corresponding buttons 40 positioned on the surface 38 of the glove 36. These buttons 40 may be matched to certain points of interest or features F, and when pressed or actuated, would generate a signal to the controller 14 for use in generating the feature data 16. Of course, this analog signal may also be part of the feature data 16 that is translated or decoded by the central controller 22.

In this embodiment, the glove 36 includes four different regions or buttons 40 positioned on the backside of the glove 36. In addition, each button 40 includes an identifying icon 42 positioned thereon or associated therewith, such that the user U can quickly denote which button 40 should be activated. In this embodiment, the actuation or pressing of the button 40 can be buffered into memory, together with a timestamp of the actuation. Thereafter, this feature data 16 can be periodically or immediately transmitted or used to generate further feature data 16 to be transmitted to the central controller 22. In addition, the above-discussed navigation data 34 can also be associated with this timestamp and feature data 16.

In many instances, communication (either from the communication device 20 or another communication device associated with the user U) cannot be established immediately. In this manner, when the glove 36 (or marker unit 12) comes within active range of a transmitter (e.g., a belt-blaster, a control module, etc.), the current value stored in the buffer can be read and cleared. This value (or feature data 16) would have the user information of the transmitter added, and then be transmitted through any available communication device 20. In this manner, the central controller 22 receives this feature data 16 and is capable of placing a marker or visual representation of the feature F based upon the user data and/or navigation data 34, together with the timestamp information. Any number of buttons and actuatable or interactive mechanisms and arrangements can be used.

In another preferred and non-limiting embodiment, and as illustrated in FIG. 2, the marker unit 12 (or controller 14) can be activated through voice control. In particular, the activation device 18 may be in the form of, or integrated with, a voice recognition device 44. In this manner, the voice recognition device 44 could generate at least a portion of the feature data 16 based upon the voice input of the user U. In particular, the device 44 would capture the user's voice or command and use voice recognition software or routines to determine or identify the feature F, or information or data associated with the feature F.

Such an arrangement would allow for more flexibility in the type of features F or hazards identified, as the user U would be given a larger range of potential descriptions and identifications. In addition, the user U could provide distances or other measurements, e.g., from the user U to the feature F, and provide other additional details that will allow for a more accurate mapping process. For example, without such an arrangement, the system 10 may identify the feature F as being at the user's location, which would be based upon the navigation data 34. However, a more accurate indication of the location of the feature F could be verbally provided by the user U, such as the input of “I am six feet from a window.” The system 10, or software implemented on the system 10, could then identify that the user U is close to a particular wall or other surface and “place” the window (feature F) at that location in the model or visual representation 30 of the structure.

The voice recognition device 44 (or software) may be positioned either in connection with some other voice or speaker module at or near the user's face, or alternatively based upon software or other routines located on another controller in the vicinity or associated with the user U, such as on the personal inertial navigation unit 32. Still further in this embodiment, the voice recognition device 44 can be configured or programmed to provide instant feedback on whether the command or description was acceptable. In addition, as discussed above, the feature data 16 provided by the voice recognition device 44 would include a timestamp and be either directly or indirectly transmitted from the communication device 20, which may be paired with another communication device (as discussed above).

It is also envisioned that one or more of the components of the system 10 can be powered by an energy harvesting mechanism 46, as illustrated in FIG. 1. For example, the controller 14, activation device 18, and communication device 20 of the marker unit 12 may be individually or collectively powered through such an energy harvesting mechanism 46. Further, the energy harvesting mechanism 46 may be in the form of a switch, a motion-based arrangement, a heat-based arrangement, or the like.

The presently-invented system 10 and associated methods provide unique ways of combining data from multiple different sources into a single interface, i.e., the central controller 22, for use in complete scene management and awareness. Accordingly, the system 10 of the present invention provides for effective on-site management of various resources. For example, the central controller 22 may obtain data from multiple users U, as well as the equipment and components associated with the user U, e.g., personal inertial navigation units 32, self-contained breathing apparatus units, global positioning systems, geographic information systems, and the like. In addition, the feature data 16 can be used to manage a variety of different resources, including, but not limited to, users U, individual units, teams of units, vehicles, equipment, and the like.

With reference to FIG. 3, and in one preferred and non-limiting embodiment, a complete resource management interface 48 can be provided on the display device 28 for use by a controller or commander C. In such an environment, this commander C must manage and control a variety of resources R, such as vehicles V, equipment E, and firefighters FF. Accordingly, this resource management interface 48 can provide valuable information to the commander C for use in scene management. For example, this resource management interface 48 may display a three-dimensional model including a wireframe representation of the current structure, three-dimensional models representing individual users U wearing personal inertial navigation units 32, models of vehicles V currently on the scene, models and icons marking out structural way points and other features F, and the like. In addition, the commander C is provided with some input device 50 for providing information and data to the central controller 22. Any known data input method, device, or arrangement can be used in connection with the system 10 and method of the present invention.

For example, while feature data 16 can be provided from each individual marker unit 12, further feature data 52 can be input directly by the commander C at the central controller 22. In addition, the feature data 16 and further feature data 52 can be used in connection with or to generate resource data 54. All of this data, whether used alone or in combination, can provide invaluable information to the commander C, such that he or she can appropriately and effectively control and manage the resources R that are deployed at the site S.

Accordingly, in one preferred and non-limiting embodiment, the commander C (or end user) can select or manually add additional features F (or resources R) at the central controller 22. Also, the individual users U deployed at the site S can use the marker units 12, personal inertial navigation units 32, or other equipment or components to communicate, transmit, or otherwise provide information and data to the central controller 22. In this manner, an accurate visual representation 30 of the site S or structure can be provided, together with a resource management interface 48, to provide overall management and control functionality.

As further illustrated in one preferred and non-limiting embodiment in FIG. 3, the navigation data 34 (or location data) allows for additional modeling or identification of features F. As discussed above, the navigation data 34, or other information or data directly or indirectly input to the central controller 22, can be used in generating further feature data 52 and/or resource data 54. In this manner, additional structural details can be added to the visual representation 30. In one example, the central controller 22 can include routines that monitor all the collected data for each user U, and check this information against common features F. For example, if it is noticed that several of the users' heights had increased at a steady rate at the same region, it can be inferred or determined that there is a staircase or ramp located beginning at the average spot that the climb began, and at an ending at the average leveling-off point. This allows for a stairway to be drawn into the visual representation 30 of the structure or site S, and help to provide a more detailed picture of the scene. This may also be compared to similar information being determined from the personal inertial navigation unit 32, which typically is doing similar calculations, which help in further clarifying and providing accuracy of the data. This method is particularly useful in connection with certain features F including, but not limited to, stairways, elevators, escalators, ladders, and drop-offs.

As discussed above, the navigation data 34 of one or more of the users U can be used to determine at least a portion of the feature data 16. The determination of some or all of the feature data 16 may occur locally (e.g., using the personal inertial navigation unit 32 of the user U or the marker unit 12) or remotely (e.g., using the central controller 22 or some other remote computing device). In one preferred and non-limiting embodiment, a series of position estimates (navigation data 34) is determined for one or more users U to determine the trend or estimated path of the user U. This analytical and determinative process may user singular value decomposition of other mathematical methods or algorithms to determine some or all of the feature data 16. One result of this process is the determination of a plane, where the normal direction describes the structure or feature F orientation and the mean relates to the position.

Continuing with this embodiment, the vertical slope of this plane can be used to estimate or predict that the structure (or feature F within the building or structure) is a level floor (no slope), a wheelchair ramp (1:12 ratio slope), a staircase (about a 30°-35° slope), a ladder (about a 45° slope), and/or a vertical ladder (about a 90° slope). A similar determination may be made with respect to moving reference frames, such as an elevator (about a 90° slope) and/or an escalator (about a 30°-35° slope). It is noted that additional detection criteria relating to the analysis of the navigation data 34 of the user may be useful in making such determinations, such as determinations made with respect to a moving reference frame. Accordingly, the existing and dynamically-created navigation data 34 can be used in creating the feature data 16, for use in identifying and placing features F in the visual representation 30 on the display device 28.

In a further preferred and non-limiting embodiment, correlations between the data from multiple users U can help in identifying doors, hallways, windows, and the like. For example, if there is an instance where every user U came from different locations and converged at a single point before diverging again, it can be inferred and determined that a doorway, window, or similar point-of-entry is located at that position. Similarly, if every user U that moved through a certain area stayed in a close line while traversing over a certain distance, it can be inferred or determined that either a hallway or, at the very least, a safe path is located at that position. Such a feature F can then be marked or identified on the visual representation 30.

By using the system 10 of the present invention, it is possible to build an accurate three-dimensional wireframe model of a structure or building by analyzing the navigation data 34 (which may form part of the feature data 16) of multiple users U. Using the feature data 16, further feature data 52, and/or resource data 54, boundaries can be drawn on by locating other building or structure features F and extrapolating from them. The system 10 may identify common traversal techniques, such as left- and right-handed searches, and may use these techniques to model and identify walls in rooms. These walls can then be analyzed to determine whether they are internal or external walls, and can be propagated to additional floors, where appropriate.

Accordingly, the system 10 and method of the present invention builds an accurate and detailed visual representation 30 or model that will allow for further incident and resource management. The user U, whether the commander C or the firefighter FF, may now visually see the entire incident and structure and make decisions for the best tactics. Such decisions can be made (if by the commander C) at the resource management interface 48 based upon the information and data provided at the input device 50. In this manner, the commander C may use the resource management interface 48 to assign resources R and tasks, as necessary, and to manage these resources R as they work towards these tasks. Accordingly, the resource data 54 may also include assignments, tasks, commands, and other data and information, and be provided to the resource R from the central controller 22. Accordingly, this resource data 54 may be provided, such as wirelessly provided, to a device located on or carried by the resource R.

Further, the system 10 may provide for the appropriate acknowledgments and/or reception of resource data 54 by the resource R, such that commander C can verify the assignment or task. It is further envisioned that the system 10 allows the user U or commander C to mark or identify certain resources R as belonging to another commander C, who would then be able to manage only those resources R or units from a separate instance of the system 10, or software that they are implementing or utilizing. In this manner, while the system 10 may have access to all the data and information within the entire network, control and modification of the resources R and resource data 54 may be limited to specific commanders C, sub-systems, or boundaried networks, such as those resources R under a specific commander C control. In addition, a main user U or commander C may have the ability to dictate who has control of whom, and who will be in charge of managing a specific resource R or sub-commanders.

In a further preferred and non-limiting embodiment, the system 10, such as at the central controller 22, can generate an electronic version of existing paper tactical worksheets for use in managing the incident. Such an electronic worksheet may be integrated with the information and data generated by or through the visual representation 30 or model to help generate quick views of the current scene. For example, vehicles V with GPS would appear in the electronic tactical worksheet, which may be displayed on the resource management interface 48, indicating where they are positioned. Further, the command structure may be provided and will allow for the user U or commander C to manipulate, modify, create, or delete tasks and assignments to the resources R. As such resource data 54 is put into place in the command structure, and based upon the overall understanding of feature F placement, user U placement, and resource R placement, tasks and assignments can be appropriately dictated and provided. The user U or commander C will be able to see what resources R are currently in use, where these resources R are located, what the incident currently looks like, what resources R are still available, notes about the amount of water recommended for the current incident, and other similar information. This provides the user U or commander C the ability to completely manage the incident and resources R.

In another preferred and non-limiting embodiment, the system 10, and specifically the input device 50, allows for the input, digitalization, analysis, processing, and/or review of existing documents D. In particular, and as is known, presently the user U or commander C must use documents D, such as drawings and worksheets, in order to manage the scene. As discussed above, while the present system 10 allows for such drawings and worksheets to be digitally generated and displayed with detailed and accurate information, the system 10 also permits for the input of existing documents D. This information can be used to verify and/or compare the existing information with the information that is being generated regarding the site S or structure. Accordingly, the presently-invented system 10 can be used to provide a more accurate representation and model of the site S or structure, which, after the incident, can be provided in paper form to the owner, and stored by the system 10 for future use. Accordingly, the resource management interface 48 permits the user U or commander C to see exactly where resource R or feature F is located, both inside and outside of the structure. This permits the user U or commander C to manage and control all of the incident activities at one central location, as opposed to relying upon multiple disparate data sources and documents D.

In this manner, the presently-invented system and method enables communication and three-dimensional construction of an accurate model to provide users U with important context as to the site S, structure, and hazards that are being faced. The system 10 provides automated data generation, which may or may not be augmented with additional data, for resource management and control. Further, all of the data sources can be shared automatically with all other users U in the system 10, and the automation of this mapping or modeling allows the incident commander C to complete other important tasks at the scene.

The presently-invented system 10 and method helps to build context and situational awareness for the users U and commanders C in an accurate and dynamic environment. With this information, the user U or commander C can better manage all the activities and resources R at a particular site S or scene, such as the location of the user U, the location of equipment associated with the user U, tasks or assignments that have been assigned to a user U or resource R, and the like. Further, all of this information can be integrated with the navigation data 34 to provide a real-time and dynamic model and representation of the site S. Further, the system 10 and method of the present invention allows for the commander C to make informed decisions about what units he or she has available, and how best to assign them to deal with the present scenario. For example, the user U or commander C can see when the units are in need of relief and what units are available to replace them or to rescue them in the event of a downed or lost resource R. Further, by using the resource management interface 48, the user U or commander C can visually manage where vehicles V are located on the scene, without the need to use valuable radio time finding out where the vehicles V are positioned. Accordingly, the system 10 and method will help to improve the safety and efficiency of all users U.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A feature location and management system, comprising:
at least one user-associated marker unit, including:
(a) controller configured to generate feature data associated with at least one feature located at a site;
(b) an activation device in communication with the controller and configured to activate the controller to generate the feature data; and
(c) a communication device in communication with the controller and configured to transmit at least a portion of the feature data; and
at least one central controller configured to:
(a) directly or indirectly receive at least a portion of the feature data transmitted by the marker unit; and
(b) generate display data based at least partially on the received feature data.

2. The system of claim 1, further comprising at least one display device configured to generate a visual representation of at least a portion of the site based at least partially on the display data.

3. The system of claim 2, wherein the visual representation is at least partially a three-dimensional visual representation.

4. The system of claim 1, wherein the activation device is configured to activate based upon at least one user motion.

5. The system of claim 4, wherein at least one user motion is automatically associated with a specified feature.

6. The system of claim 1, wherein the at least one feature comprises at least one of the following: a surface, a wall, a ceiling, a floor, a door, a window, a staircase, a ramp, an object, a structure, a user, a vehicle, a point of interest, an entrance, an exit, an elevator, an escalator, a fire point, a structural hazard, a ladder, a drop-off, a condition, an event, or any combination thereof.

7. The system of claim 1, wherein the activation device comprises at least one surface configured for user contact.

8. The system of claim 7, wherein the surface comprises at least one button on at least one of the following: a glove, equipment, an article of clothing, a hat, a boot, or any combination thereof.

9. The system of claim 7, wherein the at least one button is associated with a specified feature.

10. The system of claim 1, wherein at least one component of the at least one marker unit is powered by at least one energy harvesting mechanism.

11. The system of claim 1, wherein the feature data comprises at least one of the following: location data, distance data, user data, device data, feature identification data, time data, communication data, motion data, gesture data, description data, resource data, activity data, icon data, navigation data, path data, boundary data, task data, document data, condition data, event data, object data, or any combination thereof.

12. The system of claim 1, further comprising at least one voice recognition device configured to generate at least a portion of the feature data based at least partially on a user's voice input.

13. The system of claim 1, wherein the at least one marker device comprises at least one personal inertial navigation unit.

14. A feature location and management system, comprising a central controller configured to: (a) directly or indirectly receive feature data associated with at least one feature located at a site; and (b) generate display data based at least partially on the received feature data;
wherein the feature data comprises at least one of the following: location data, distance data, user data, device data, feature identification data, time data, communication data, motion data, gesture data, description data, resource data, activity data, icon data, navigation data, path data, boundary data, task data, document data, condition data, event data, object data, or any combination thereof.

15. The system of claim 14, further comprising at least one display device configured to generate a visual representation of at least a portion of the site based at least partially on the display data.

16. The system of claim 15, wherein the visual representation is at least partially a three-dimensional visual representation.

17. The system of claim 14, wherein the central controller is further configured to generate further feature data at least partially based upon navigation data received from at least one personal inertial navigation unit associated with a specific user.

18. The system of claim 14, wherein the central controller is further configured to generate resource data at least partially based upon the feature data.

19. The system of claim 18, wherein the central controller is further configured to:
accept input data from at least one user; and
generate resource management data based on at least a portion of the resource data and at least a portion of the input data.

20. A feature location and management method, comprising:
generating feature data associated with at least one feature located at a site;
transmitting at least a portion of the feature data; and
directly or indirectly receiving at least a portion of the feature data at a remote location; and
generating display data based at least partially on the received feature data.
